(19) United States
(12) Patent Application Publication
(10) Pub. No.: US 2026/0080226 A1
(43) Pub. Date: Mar. 19, 2026

(54) METHOD AND ELECTRONIC DEVICE FOR PROCESSING DATA USING GENERATIVE ARTIFICIAL INTELLIGENCE, AND NON-TRANSITORY COMPUTER-READABLE STORAGE MEDIUM

(71) Applicant: COMPAL ELECTRONICS, INC., Taipei (TW)

(72) Inventors: HUI-WEN CHAN, Taipei (TW); CHING LIN, Taipei (TW)

(73) Assignee: COMPAL ELECTRONICS, INC., Taipei (TW)

(21) Appl. No.: 19/328,332

(22) Filed: Sep. 15, 2025

Related U.S. Application Data
(60) Provisional application No. 63/694,913, filed on Sep. 15, 2024.

(51) Int. Cl. G06N 3/0475; G06F 3/04883; G06F 3/04886

(52) U.S. Cl. CPC G06N 3/0475; G06F 3/04883; G06F 3/04886

(57) ABSTRACT

A method and an electronic device for processing data using generative artificial intelligence (AI), and a non-transitory computer-readable storage medium are provided. The method is executed by the electronic device and includes: obtaining and displaying corresponding word information based on a startup input operation performed by a user; obtaining and displaying corresponding handwriting recognition information based on a handwriting input operation performed by the user; generating weight adjustment ratio information based on a generated content weight adjustment operation performed by the user; generating an AI data processing mode based on a generated content selection input operation performed by the user; generating an AI-generated content by using generative AI based on the word information, the handwriting recognition information, the weight adjustment ratio information, and the AI data processing mode; and displaying the AI-generated content.

### BACKGROUND OF THE INVENTION

### 1. Field of the Invention

The present disclosure relates to data processing technologies, and in particular, to a method and an electronic device for processing data using generative artificial intelligence (AI), and a non-transitory computer-readable storage medium.

### 2. Description of the Related Art

Currently, for example, electronic devices used for data processing of read content or meeting minutes on the market usually open a plurality of application programs through the electronic devices and use different application programs to perform a plurality of function links, so as to process the read articles (or the content of meeting minutes) for the inputted content of different application programs of a user, and then integrate the content to generate processed content. Although this method can obtain the processed content of reading (or meeting minutes) data, this data processing method is less convenient for the user to use.

Therefore, how to solve the foregoing problems in the related art is the main focus of the present disclosure.

### BRIEF SUMMARY OF THE INVENTION

Therefore, an objective of the present disclosure is to provide a method and an electronic device for processing data using generative artificial intelligence (AI), and a non-transitory computer-readable storage medium, so as to overcome shortcomings in the prior art.

To achieve the foregoing objective, the present disclosure provides a method for processing data using AI, executed by an electronic device running a plurality of program instructions, and including the following steps: (A) obtaining and displaying corresponding word information based on a startup input operation performed by a user; (B) obtaining and displaying corresponding handwriting recognition information based on a handwriting input operation performed by the user; (C) generating weight adjustment ratio information based on a generated content weight adjustment operation performed by the user; (D) generating an AI data processing mode based on a generated content selection input operation performed by the user; (E) generating an AI-generated content by using generative AI based on the word information, the handwriting recognition information, the weight adjustment ratio information, and the AI data processing mode; and (F) displaying the AI-generated content.

In some embodiments of the method, between step (B) and step (E), the method further includes the following steps: (G) determining whether the word information or the handwriting recognition information has a specific marker; (H) generating key handwriting information based on a word corresponding to the specific marker when the word information or the handwriting recognition information has the specific marker, where when the word information or the handwriting recognition information has the specific marker, in step (E), the AI-generated content is generated through the generative AI based on the word information, the handwriting recognition information, the weight adjustment ratio information, the AI data processing mode, and the key handwriting information.

In some embodiments of the method, words related to the key handwriting information in the AI-generated content are presented in different display manners.

In some embodiments of the method, between step (B) and step (E), the method further includes the following steps: (I) determining whether a total number of words in the handwriting recognition information is less than a preset number of words; and (J) generating and displaying a warning window when the total number of words is less than the preset number of words.

In some embodiments of the method, the electronic device includes a graphical user interface, the graphical user interface has a first display block and a second display block, the word information is displayed in the first display block, the handwriting recognition information is displayed in the second display block, and between step (B) and step (D), the method further includes the following step: (K) splitting, based on a screen splitting selection operation performed by the user, the graphical user interface into the first display block and the second display block from up to down, or splitting the graphical user interface into the first display block and the second display block from left to right.

In some embodiments of the method, the electronic device includes a graphical user interface, the graphical user interface has a first display block and a second display block, the word information is displayed in the first display block, the handwriting recognition information is displayed in the second display block, and after step (C), the method further includes the following step: (L) adjusting a display block size of each of the first display block and the second display block based on the weight adjustment ratio information.

In some embodiments of the method, a graphical user interface of the electronic device has a weight control bar, the weight control bar has an adjustment element and two variable number elements, and the user performs the generated content weight adjustment operation by moving the adjustment element or adjusting numbers of the variable number elements.

In some embodiments of the method, when the word information is related to content of meeting minutes, the AI data processing mode is a general format processing mode, a risk assessment processing mode, a goal-oriented processing mode, or an advantage analysis processing mode.

In some embodiments of the method, when the word information is related to read content, the AI data processing mode is a summary processing mode, an advanced search processing mode, or a translation processing mode.

The present disclosure further provides a non-transitory computer-readable storage medium, storing a plurality of program instructions, the program instructions, after being read by an electronic device, being able to perform the foregoing method.

The present disclosure further provides an electronic device for processing data using generative AI, including: a storage unit, storing a plurality of program instructions; a graphical user interface, having a first display block, a second display block, a third display block, and a weight control bar; and a weight control bar; and an intelligent processing unit, electrically connected to the storage unit to read and execute the program instructions, to perform a plurality of following operations: (A) obtaining word information based on a startup input operation performed by a user on the graphical user interface, and displaying the word information on the first display block; (B) obtaining handwriting recognition information based on a handwriting input operation performed by the user on the second display block, and displaying the handwriting recognition information on the second display block; (C) obtaining weight adjustment ratio information based on a generated content weight adjustment operation performed by the user on the weight control bar; (D) obtaining an AI data processing mode based on a generated content selection input operation performed by the user on the third display block; (E) generating an AI-generated content by using generative AI based on the word information, the handwriting recognition information, the weight adjustment ratio information, and the AI data processing mode; and (F) displaying the AI-generated content on the third display block.

In some embodiments of the electronic device, between operation (B) and operation (E), the operations further include the following operations: (G) determining whether the word information or the handwriting recognition information has a specific marker; (H) generating key handwriting information based on a word corresponding to the specific marker when the word information or the handwriting recognition information has the specific marker, where when the word information or the handwriting recognition information has the specific marker, in operation (E), the AI-generated content is generated through the generative AI based on the word information, the handwriting recognition information, the weight adjustment ratio information, the AI data processing mode, and the key handwriting information.

In some embodiments of the electronic device, words related to the key handwriting information in the AI-generated content are presented in different display manners.

In some embodiments of the electronic device, between operation (B) and operation (E), the operations further include the following operations: (I) determining whether a total number of words in the handwriting recognition information is less than a preset number of words; and (J) generating a warning window and displaying the warning window on the graphical user interface when the total number of words is less than the preset number of words.

In some embodiments of the electronic device, the first display block has a screen splitting element. Between operation (B) and operation (D), the operations further include the following operation: (K) splitting, based on the screen splitting selection operation performed by the user on the screen splitting element, the graphical user interface into the first display block and the second display block from up to down, or splitting the graphical user interface into the first display block and the second display block from left to right.

In some embodiments of the electronic device, after operation (C), the operations further include the following operation: (L) adjusting a display block size of each of the first display block and the second display block based on the weight adjustment ratio information.

In some embodiments of the electronic device, the weight control bar has an adjustment element and two variable number elements. The user performs the generated content weight adjustment operation by moving the adjustment element or adjusting numbers of the variable number elements.

In some embodiments of the electronic device, when the word information is related to content of meeting minutes, the third display block has a general format processing element, a risk assessment processing element, a goal-oriented processing element, and an advantage analysis processing element, and the user presses the general format processing element, the risk assessment processing element, the goal oriented processing element, or the advantage analysis processing element in the third display block to perform the generated content selection input operation, so that the AI data processing mode is a general format processing mode, a risk assessment processing mode, a goal-oriented processing mode, or an advantage analysis processing mode.

In some embodiments of the electronic device, when the word information is related to read content, the third display block has a summary element, an advanced search element, and a translation element, and the user presses the summary element, the advanced search element, or the translation element in the third display block to perform the generated content selection input operation, so that the AI data processing mode is a summary processing mode, an advanced search processing mode, or a translation processing mode.

In some embodiments of the electronic device, when the word information is related to read content, the third display block has a user input interface, and the user selects the user input interface in the third display block to perform the generated content selection input operation, to generate the AI data processing mode.

Therefore, effects of the present disclosure are that the method is performed by reading the foregoing program instructions through the electronic device and by splitting the screen of the graphical user interface. In this way, the electronic device is not required to open the plurality of application programs, so that more than two operation behaviors may be simultaneously performed on a single device through functional connection of a single application program, and the AI-generated content of the processed read data may be displayed correspondingly, which is more convenient for the user to use. Moreover, the weight ratio of the content of the meeting minutes or the handwritten notes of the user is increased through the specific marker, so that the AI-generated content is more in line with preference of the user.

### BRIEF DESCRIPTION OF THE DRAWINGS

FIG. 1 is a block diagram of an electronic device for processing data using generative artificial intelligence (AI) according to an embodiment of the present disclosure.

FIG. 2A is a schematic diagram illustrating that a graphical user interface of an electronic device is presented vertically and a screen is split from left to right according to this embodiment.

FIG. 2B is a schematic diagram of a first display block, a second display block, and a third display block of a graphical user interface according to this embodiment.

FIG. 2C is a schematic diagram illustrating that a graphical user interface is presented vertically and a screen is split from up to down according to this embodiment.

FIG. 2D a schematic diagram illustrating that a graphical user interface is presented horizontally and a screen is split from left to right according to this embodiment.

FIG. 3A is a schematic diagram of another implementation of a graphical user interface of an electronic device according to this embodiment.

FIG. 3B is a schematic diagram of a first display block and a third display block of another implementation of a graphical user interface according to this embodiment.

FIG. 4 is a flowchart illustrating that an electronic device performs a method for processing data using generative AI in the present disclosure according to this embodiment.

FIG. 5A is a schematic diagram of a first implementation in which a weight control bar of an electronic device is configured to perform a generated content weight adjustment operation according to this embodiment.

FIG. 5B is a schematic diagram of a second implementation in which a weight control bar of an electronic device is configured to perform a generated content weight adjustment operation according to this embodiment.

FIG. 6A is a schematic diagram illustrating that weight adjustment ratio information of an electronic device is 80 to 20 according to this embodiment.

FIG. 6B is a schematic diagram illustrating AI-generated content displayed by an electronic device when weight adjustment ratio information is 80 to 20 and an AI data processing mode is a risk assessment processing mode according to this embodiment.

FIG. 7A is a schematic diagram illustrating that weight adjustment ratio information of an electronic device is 20 to 80 according to this embodiment.

FIG. 7B is a schematic diagram illustrating AI-generated content displayed by an electronic device when weight adjustment ratio information is 20 to 80 and an AI data processing mode is a risk assessment processing mode according to this embodiment.

FIG. 8A is a schematic diagram illustrating that handwriting recognition information displayed in a second display block has a specific marker according to this embodiment.

FIG. 8B is a schematic diagram illustrating AI-generated content displayed by an electronic device when word information displayed in a first display block or handwriting recognition information displayed in a second display block is determined to have no specific marker according to this embodiment.

FIG. 8C is a schematic diagram illustrating AI-generated content displayed by an electronic device when handwriting recognition information displayed in a second display block is determined to have a specific marker according to this embodiment.

FIG. 9A is a schematic diagram illustrating a display block size of each of a first display block and a second display block when weight adjustment ratio information is 60 to 40 according to this embodiment.

FIG. 9B is a schematic diagram illustrating a display block size of each of a first display block and a second display block when weight adjustment ratio information is 30 to 70 according to this embodiment.

### DETAILED DESCRIPTION OF THE INVENTION

To fully understand the purpose, features, and effects of the present disclosure, the present disclosure is described in detail through the following specific embodiments and the accompanying drawings. The description is as follows. It should be noted herein that a same reference numeral is used for the accompanying drawings with similar or identical structures and operating principles.

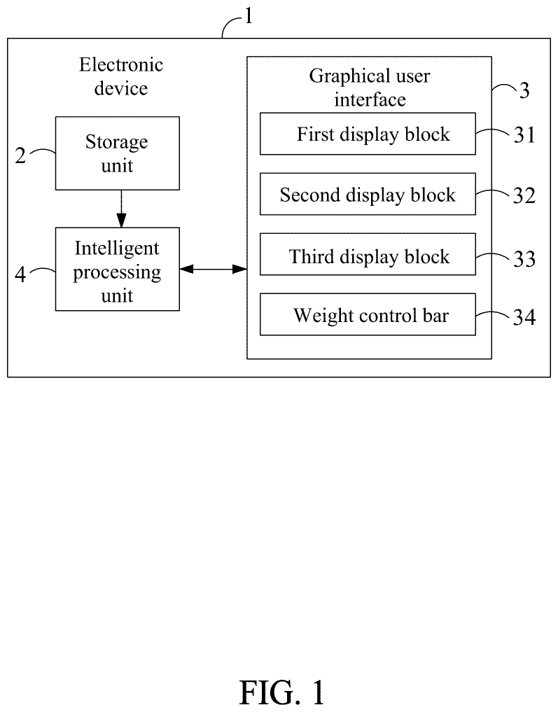

FIG. 1 is an embodiment of an electronic device 1 of processing data using generative artificial intelligence (AI) according to the present disclosure. The electronic device 1 includes a storage unit 2, a graphical user interface 3, and an intelligent processing unit 4. In this embodiment, the storage unit 2 stores a plurality of program instructions. The electronic device 1 may be a portable mobile communication device, for example, a smart phone, a tablet computer, or a notebook computer. The storage unit 2, the graphical user interface 3, and the intelligent processing unit 4 are arranged in a same engine body, but the present disclosure is not limited thereto. In another embodiment, the electronic device 1 can wirelessly communicate with a cloud server via the Internet, and the storage unit 2 and the intelligent processing unit 4 included therein are a remote cloud server.

The graphical user interface 3 has a first display block 31, a second display block 32, a third display block 33, and a weight control bar 34. The first display block 31 is configured to display content of meeting minutes or word information of read content (an article). The second display block 32 is configured for a user to perform a handwriting input operation and display corresponding handwriting recognition information accordingly. The third display block 33 is configured to display AI-generated content. The weight control bar 34 is configured for the user to perform a generated content weight adjustment operation, so as to obtain weight adjustment ratio information. Detailed operations are described later.

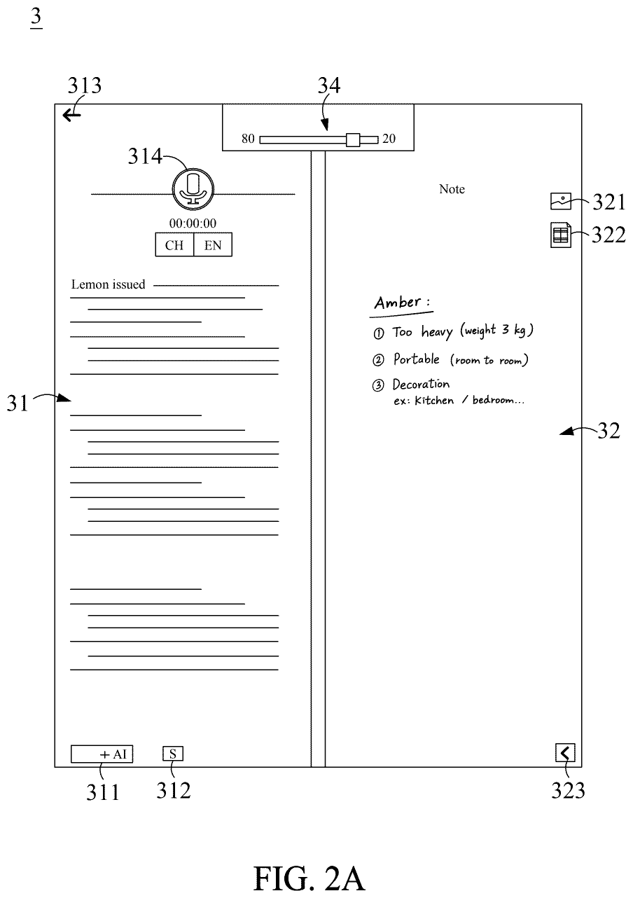

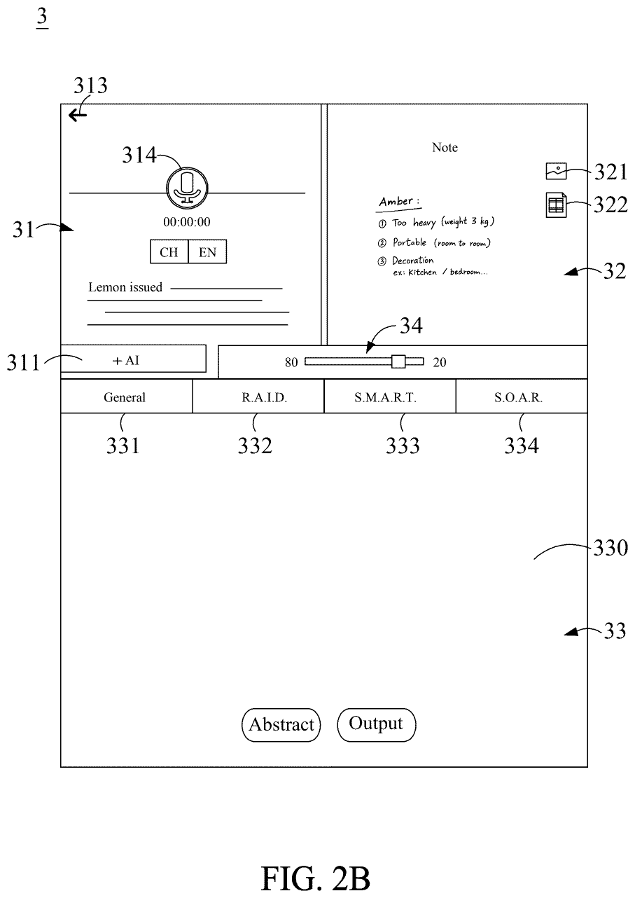

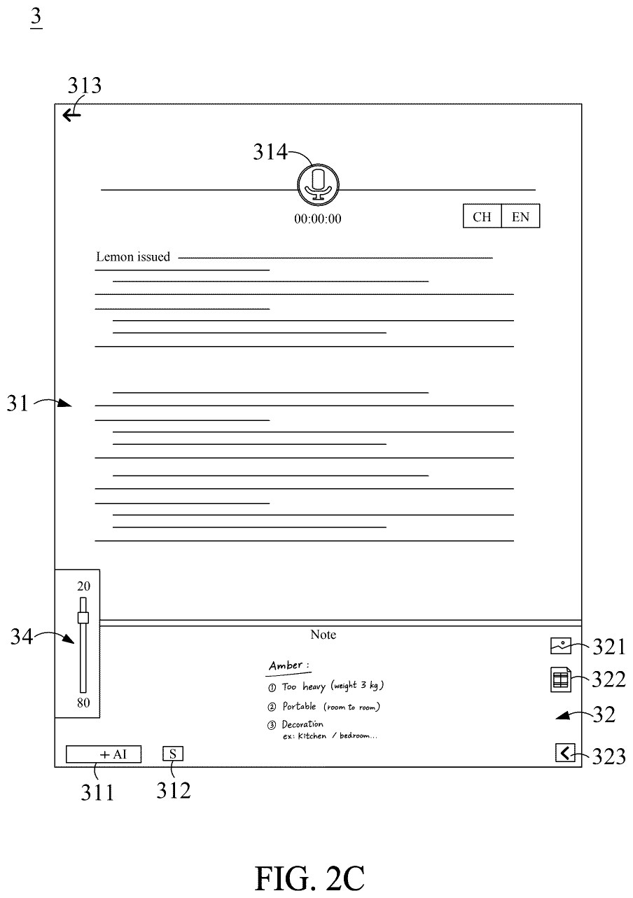

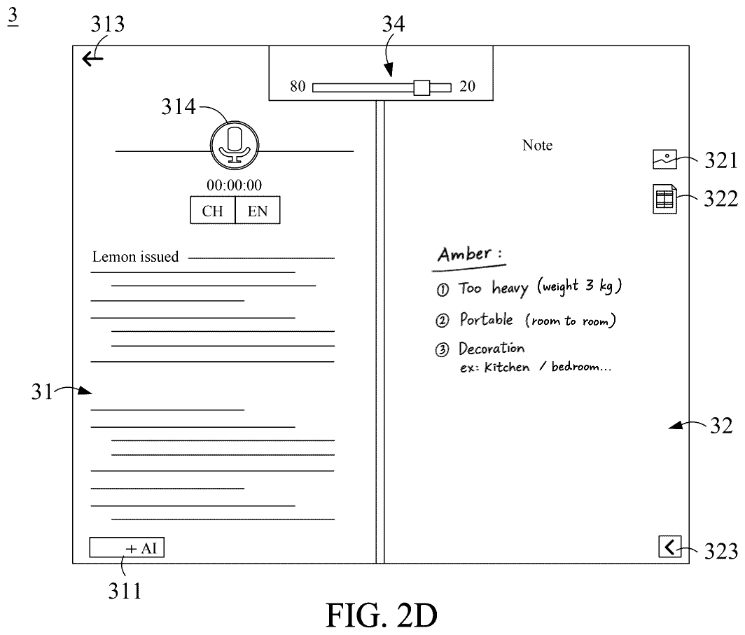

Further, reference is made to FIG. 2A, FIG. 2B, FIG. 2C, and FIG. 2D. In this embodiment, when the user clicks or touches (for example, by clicking with a mouse or touching with a stylus/finger) an icon (not shown in the figure) of meeting recording software on a preset display interface (the preset display interface includes a plurality of application program icons (not shown the figure)) of the graphical user interface 3, the electronic device 1 loads the software and the graphical user interface 3 is as shown in FIG. 2A, which is not limited thereto. In this case, the first display block 31 is configured to display word information of the content of meeting minutes. The first display block 31 has an AI content template switching element 311 for clicking or touching to evoke or close the third display block 33, a screen splitting element 312 for clicking or touching, an exit element 313 for clicking or touching to exit the preset display interface, and a recording element 314 for pressing to receive a sound. The second display block 32 has a placement element 321 for clicking or touching to place a drawing file, a conversion element 322 for clicking or touching to convert handwritten data of the user into a table, and a drawing element 323 for clicking or touching to pop up a drawing tool. When the user clicks or touches the AI content template switching element 311 to evoke the third display block 33, the graphical user interface 3 displayed by the electronic device 1 becomes as shown in FIG. 2B. The third display block 33 overlaps with a part of the first display block 31 and a part of the second display block 32. The third display block 33 has a display area 330 for displaying the AI-generated content, a general format processing element 331 for pressing (for example, clicking or touching) to generate the AI-generated content based on a general format (general), a risk assessment processing element 332 for pressing to generate the AI-generated content based on a risk assessment (namely, risk, assumption, issue, and dependency, which are referred to as R.A.I.D for short), a goal-oriented processing element 333 for pressing to generate the AI-generated content based on a goal orientation (namely, specific, measurable, achievable, relevant, and time-bound, S.M.A.R.T for short), and an advantage analysis processing element 334 for pressing to generate the AI-generated content based on an advantage analysis (namely, strength, opportunity, aspiration, and result, which are referred to S.O.A.R for short). When the user clicks or touches the AI content template switching element 311 shown in FIG. 2B again, the graphical user interface 3 displayed by the electronic device 1 changes back as shown in FIG. 2A. In addition, when the user performs a screen splitting selection operation on the screen splitting element 312, namely, for example, clicking or touching the screen splitting element 312 once, the graphical user interface 3 displayed by the electronic device 1 becomes as shown in FIG. 2C (namely, the graphical user interface 3 is split into the first display block 31 and the second display block 32 from up to down). In this case, the AI content template switching element 311 and the screen splitting element 312 are located in the second display block 32, which is not limited thereto. Further, for example, when the user clicks or touches the screen splitting element 312 shown in FIG. 2C again (that is, the screen splitting selection operation is performed again), the graphical user interface 3 displayed by the electronic device 1 changes back to be as shown in FIG. 2A (that is, the graphical user interface 3 is split into the first display block 31 and the second display block 32 from left to right), which is not limited thereto.

It should be noted that when the user places the electronic device 1 longitudinally, the graphical user interface 3 is as shown in FIG. 2A, FIG. 2B, or FIG. 2C during operation, which is not limited thereto. When the user places the electronic device 1 horizontally, the graphical user interface 3 is as shown in FIG. 2D during operation. Specifically, the electronic device 1 further includes a gravity sensor (G-sensor) (not shown in the figure). The gravity sensor is configured to generate a sensing signal corresponding to an acceleration value of the electronic device 1 in a three-axis (x, y, and z) coordinate system, and transmit the sensing signal to the intelligent processing unit 4, so that the intelligent processing unit 4 determines a placement direction of the electronic device 1 based on the sensing signal, and controls the display direction of the graphical user interface 3 based on the placement direction (for example, displayed longitudinally as shown in FIG. 2A or horizontally as shown in FIG. 2D). Because the technology of the gravity sensor is well-known to a person of ordinary skill in the art, and the technology is not a feature of the present disclosure, details thereof are omitted herein and not described again.

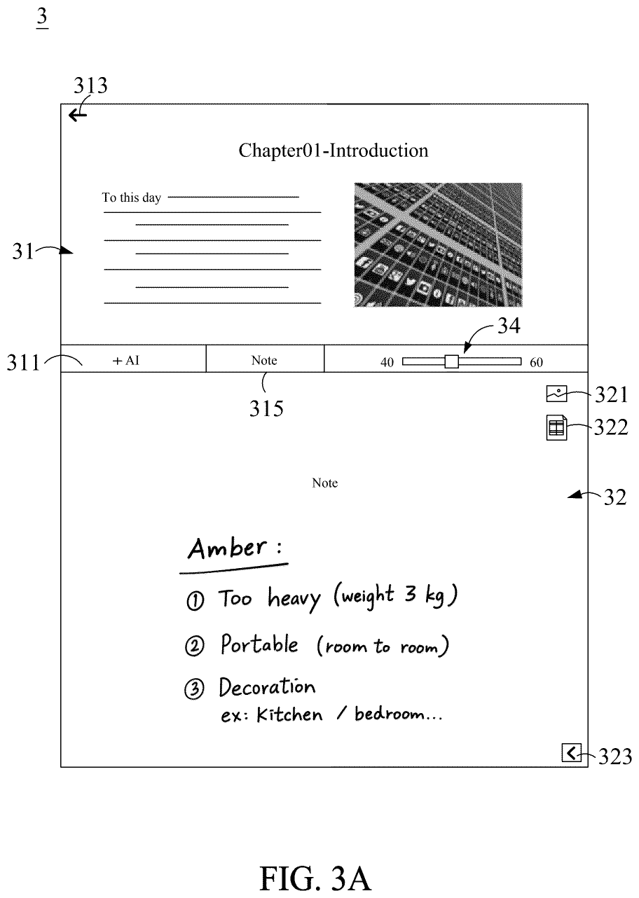

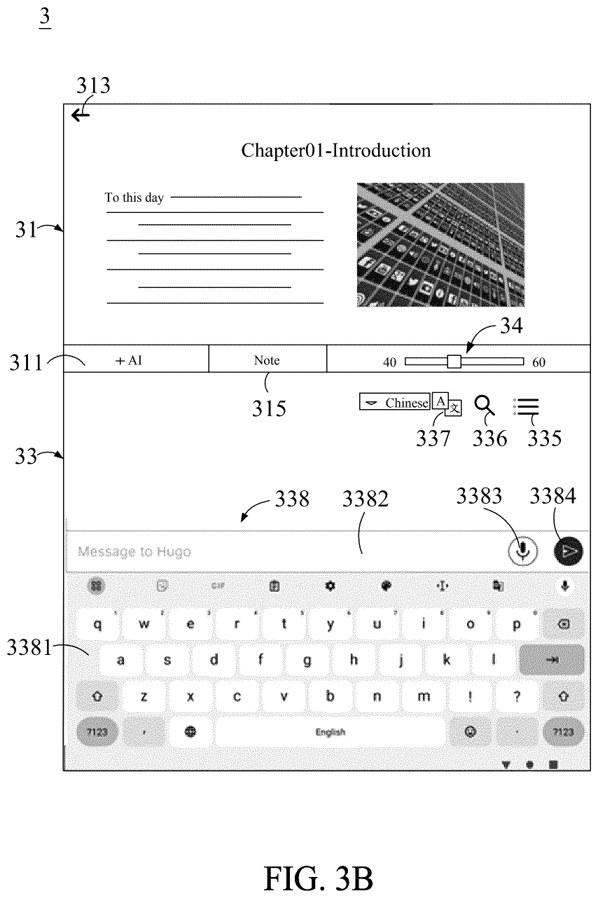

In addition, when the user clicks or touches an icon (not shown in the figure) of note-reading software on the graphical user interface 3 as the preset display interface, the electronic device 1 loads the software and the graphical user interface 3 is as shown in FIG. 3A, which is not limited thereto. In this case, the first display block 31 is configured to display word information of the read content (article). The first display block 31 has the AI content template switching element 311, the exit element 313, and a switching element 315 for clicking or touching to evoke or close the second display block 32. When the user clicks or touches the AI content template switching element 311 shown in FIG. 3A to evoke the third display block 33, the graphical user interface 3 displayed by the electronic device 1 becomes as shown in FIG. 3B. The third display block 33 has the display area 330, a summary element 335, an advanced search element 336, a translation element 337, and a user input interface 338. The user input interface 338 includes an input keyboard 3381, an input area 3382, a voice input element 3383, and a content transmission element 3384. When the user clicks or touches the switching element 315 shown in FIG. 3B to evoke the second display block 32, the graphical user interface 3 displayed by the electronic device 1 changes back to be as shown in FIG. 3A.

The intelligent processing unit 4 is electrically connected to the storage unit 2 to read and execute the program instructions, so as to perform the method for processing data using generative AI in the present disclosure.

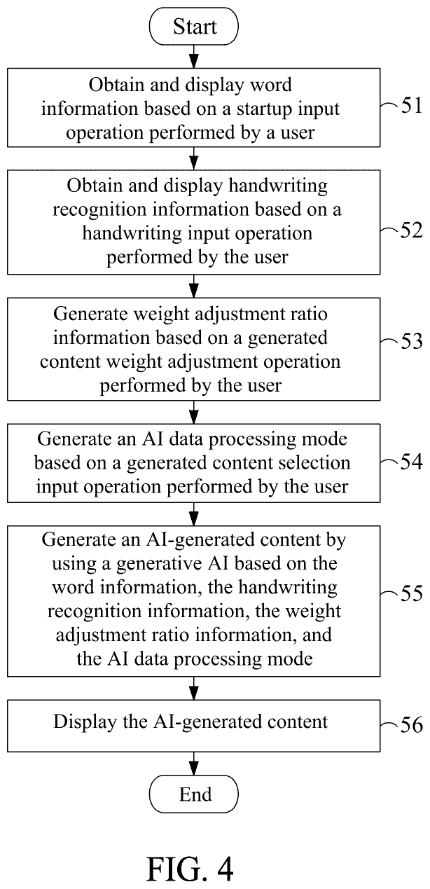

Further, FIG. 4 is a flowchart illustrating that the electronic device 1 performs, based on the program instructions, a method for processing data using generative AI in the present disclosure. The method for processing data using generative AI in the present disclosure includes the following steps 51 to 56.

Step 51: The intelligent processing unit 4 obtains word information based on a startup input operation performed by a user on the graphical user interface 3, and displays the word information on the first display block 31.

For example, in this embodiment, the startup input operation has two implementations. The first implementation of the startup input operation is that the user clicks or touches the icon of the meeting recording software on the preset display interface of the graphical user interface 3 to start the meeting recording software, and then clicks the recording element 314 on the graphical user interface 3 shown in FIG. 2A to start a recording function and record the meeting, so that the meeting recording software records voice information (for example, a 50-minute meeting recording file) and transmits the voice information to a cloud server through the electronic device 1. The cloud server uses an AI voice recognition model to convert the voice information into the word information, and sends the word information back to the intelligent processing unit 4 of the electronic device 1, so that the intelligent processing unit 4 obtains the word information and displays the word information on the first display block 31. The second implementation of the startup input operation is that the user clicks or touches the icon of the note-reading software on the preset display interface to start the note-reading software, and selects a book option from a book (or an article) menu (not shown in the figure) of the graphical user interface 3 shown in FIG. 3A, so that the intelligent processing unit 4 obtains corresponding book content based on the book option and displays the book content on the first display block 31. The book content serves as the word information.

Step 52: The intelligent processing unit 4 obtains handwriting recognition information based on a handwriting input operation performed by the user on the second display block 32, and displays the handwriting recognition information on the second display block 32.

For example, in this embodiment, a touch sensor is correspondingly arranged at a bottom of the second display block 32. The touch sensor is configured to detect a writing input (namely, the handwriting input operation) of a stylus (or a finger) on the second display block 32 to generate corresponding touch data and transmit the touch data to the intelligent processing unit 4, so that the intelligent processing unit 4 generates the handwriting recognition information based on the touch data and displays the handwriting recognition information on the second display block 32, which is not limited thereto. In another embodiment, the user may also place a drawing file by clicking or touching the placement element 321, so that the intelligent processing unit 4 obtains the handwriting recognition information based on the placed drawing file.

Step 53: The intelligent processing unit 4 generates weight adjustment ratio information based on a generated content weight adjustment operation performed by the user on the weight control bar 34.

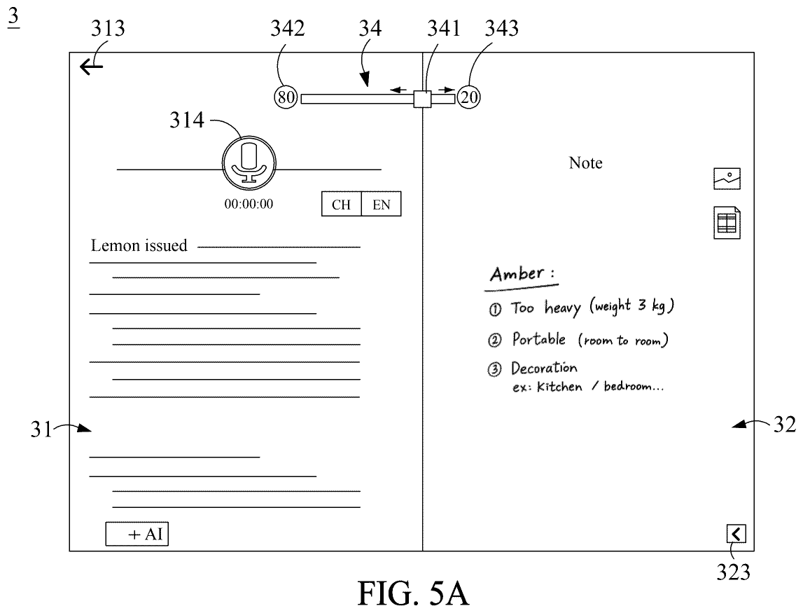

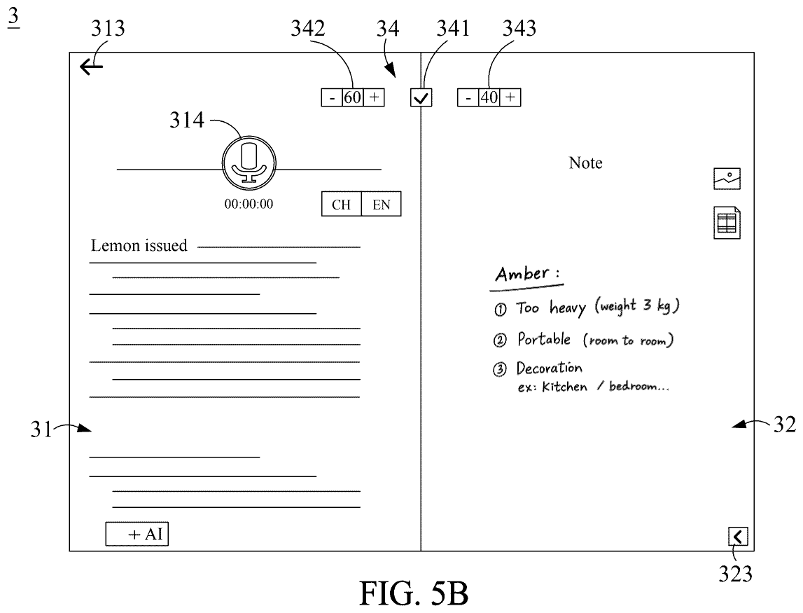

Further referring to FIG. 5A and FIG. 5B, two implementations of the generated content weight adjustment operation are described. In this embodiment, the weight control bar 34 has an adjustment element 341 and two variable number elements 342 and 343 marked with graphics. The user performs the generated content weight adjustment operation by moving the adjustment element 341 or adjusting the numbers of the variable number element 342. For example, the first implementation of the generated content weight adjustment operation is as shown in FIG. 5A. After clicking the adjustment element 341, the user drags the adjustment element 341 to left or right to set a weight, generating the weight adjustment ratio information, for example, 80:20. In other words, when the intelligent processing unit 4 generates an AI-generated content subsequently based on the content (for example, the content of meeting minutes or reading articles) displayed in the first display block 31 and the content (for example, handwriting recognition information) displayed in the second display block 32, the content in the first display block 31 accounts for 80% of the generated weight, while the content in the second display block 32 accounts for 20% of the generated weight, which is not limited thereto. In another embodiment, the weight adjustment ratio information is 80:20, which may also indicate that the content in the first display block 31 accounts for 20% of the generated weight, while the content in the second display block 32 accounts for 80% of the generated weight. The second embodiment of the generated content weight adjustment operation is that after the user clicks any of the variable number elements 342 and 343 shown in FIG. 5A, the weight control bar 34 becomes as shown in FIG. 5B. The user sets a weight by clicking the symbol “+” or “−” of any of the variable number elements 342 and 343, generating the weight adjustment ratio information, for example, 60:40. In other words, when the intelligent processing unit 4 generates the AI-generated content subsequently based on the content displayed in the first display block 31 and the second display block 32, the content in the first display block 31 accounts for 60% of the generated weight, while the content in the second display block 32 accounts for 40% of the generated weight, which is not limited thereto.

Step 54: The intelligent processing unit 4 generates an AI data processing mode based on a generated content selection input operation performed by the user on the third display block 33.

For example, in this embodiment, the generated content selection input operation has two implementations. After the user clicks or touches the icon of the meeting recording software on the preset display interface of the graphical user interface 3 and performs an operation of clicking the third display block 33, the third display block 33 is as shown in FIG. 2B. The word information displayed in the first display block 31 is related to the content of the meeting minutes. The user presses one of the general format processing element 331, the risk assessment processing element 332, the goal-oriented processing element 333, and the advantage analysis processing element 334 in the third display block 33 shown in FIG. 2B (that is, the first implementation of the generated content selection input operation is performed), so that the intelligent processing unit 4 correspondingly generates the AI data processing mode. The AI data processing mode is a general format processing mode, a risk assessment processing mode, a goal-oriented processing mode, or an advantage analysis processing mode. For example, when the user presses the general format processing element 331, the AI data processing mode is the general format processing mode. When the user presses the risk assessment processing element 332, the AI data processing mode is the risk assessment processing mode. When the user presses the goal-oriented processing element 333, the AI data processing mode is the goal-oriented processing mode. When the user presses the advantage analysis processing element 334, the AI data processing mode is the advantage analysis processing mode, which is not limited thereto.

After the user clicks or touches the icon of the note-reading software on the preset display interface of the graphical user interface 3 and performs an operation of clicking the third display block 33, the third display block 33 is as shown in FIG. 3B. The word information displayed in the first display block 31 is related to the read content. The user presses one of the summary element 335, the advanced search element 336, the translation element 337, or the user input interface 338 in the third display block 33 shown in FIG. 3B (that is, the second implementation of the generated content selection input operation is performed), so that the intelligent processing unit 4 correspondingly generates the AI data processing mode. The AI data processing mode is a summary processing mode, an advanced search processing mode, or a translation processing mode. For example, when the user presses the summary element 335, the AI data processing mode is the summary processing mode. When the user presses the advanced search element 336, the AI data processing mode is the advanced search processing mode. When the user presses the translation element 337, the AI data processing mode is the translation processing mode, which is not limited thereto. The user may also set an AI data processing manner (for example, risk assessment (R.A.I.D) processing) in the input area 3382 by pressing the input keyboard 3381 or the voice input element 3383 of the user input interface 338, and then press the content transmission element 3384 to generate the AI data processing mode (for example, a risk assessment processing mode) based on the AI data processing manner, so that the intelligent processing unit 4 obtains the AI data processing mode.

Step 55: The intelligent processing unit 4 generates the corresponding AI-generated content by using a generative AI (or referred to as a generative AI model, such as ChatGPT) based on the word information, the handwriting recognition information, the weight adjustment ratio information, and the AI data processing mode.

For example, when the weight adjustment ratio information is 80:20 and the AI data processing mode is the risk assessment (R.A.I.D) processing mode, the intelligent processing unit 4 uses the generative AI to perform generative data processing (for example, based on a transformer model, a generative adversarial network, or a diffusion model) based on the word information, the handwriting recognition information, the weight adjustment ratio information, and the risk assessment (R.A.I.D) processing mode, so as to generate the AI-generated content, which is not limited thereto. In this case, when the AI-generated content is generated, the word information accounts for 80% of the generated weight and the handwriting recognition information accounts for 20% of the generated weight.

Step 56: The intelligent processing unit 4 displays the AI-generated content in the display area 330 of the third display block 33.

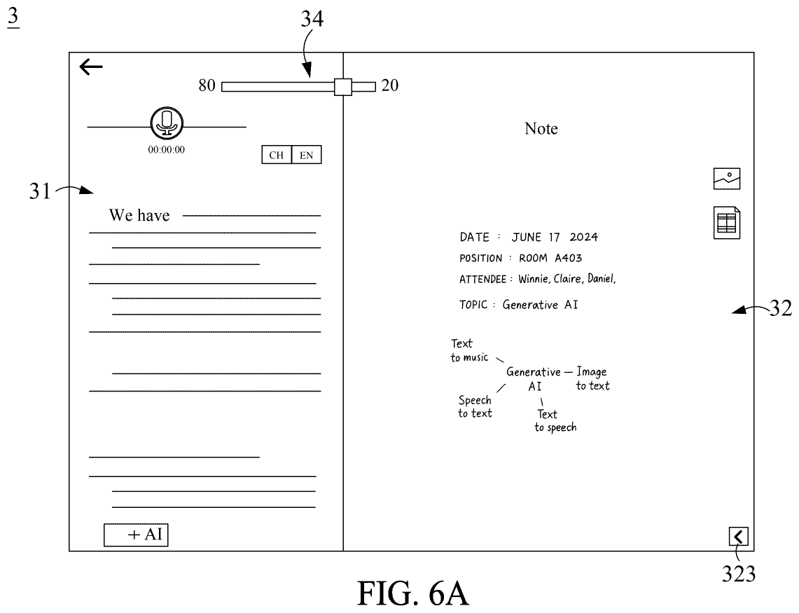

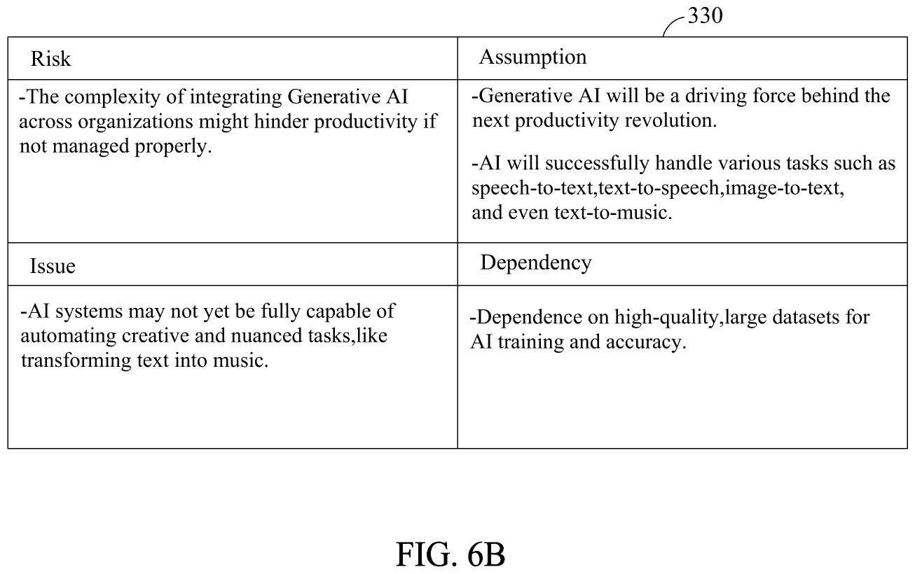

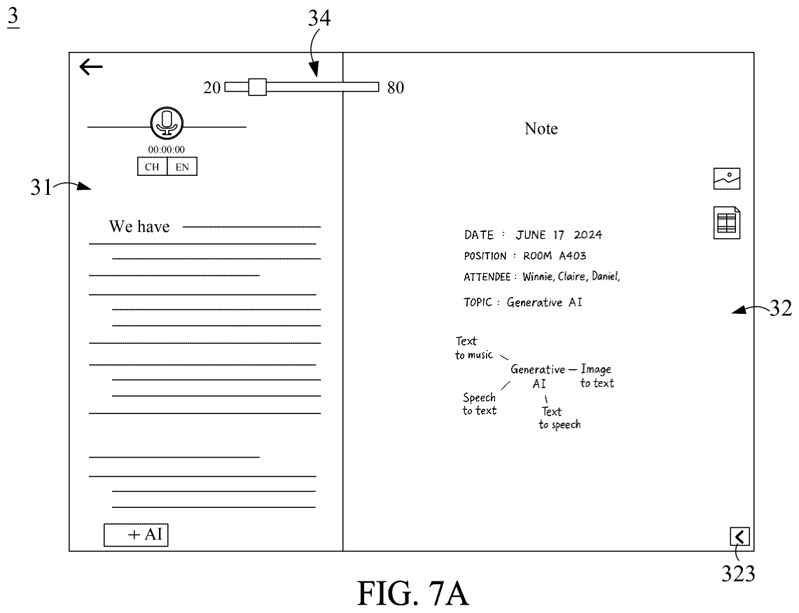

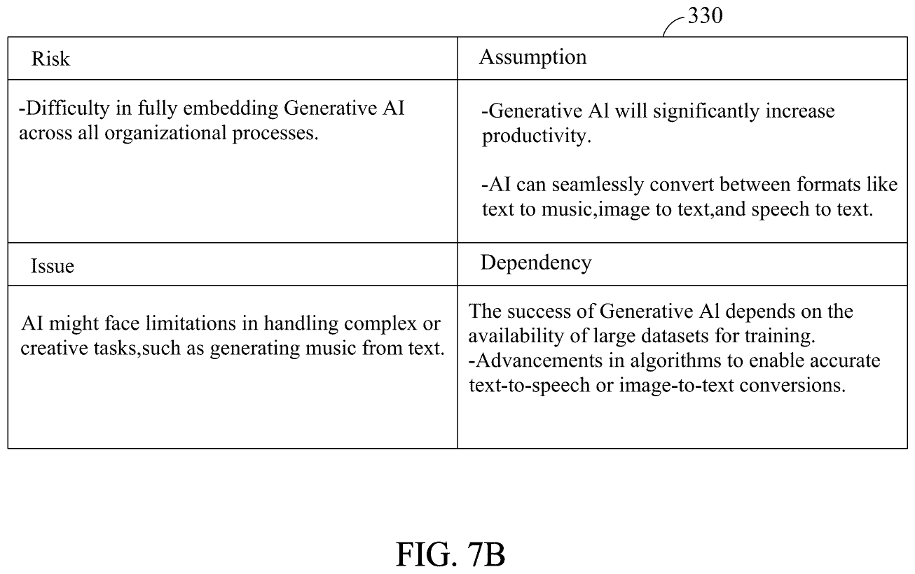

Referring to FIG. 6A, FIG. 6B, FIG. 7A, and FIG. 7B, FIG. 6A and FIG. 6B illustrate that when the weight adjustment ratio information is 80:20 and the AI data processing mode is the risk assessment (R.A.I.D) processing mode, the AI-generated content generated by the intelligent processing unit 4 is shown in the display area 330 of FIG. 6B. FIG. 7A and FIG. 7B illustrate that when the weight adjustment ratio information is 20:80 and the AI data processing mode is the risk assessment (R.A.I.D) processing mode, the AI-generated content generated by the intelligent processing unit 4 is shown in the display area 330 of FIG. 7B. It may be learned from FIG. 6A, FIG. 6B, FIG. 7A, and FIG. 7B that the respective generated weights of the word information and the handwriting recognition information are adjusted by adjusting the weight control bar 34 in the present disclosure, so that different AI-generated content may be obtained.

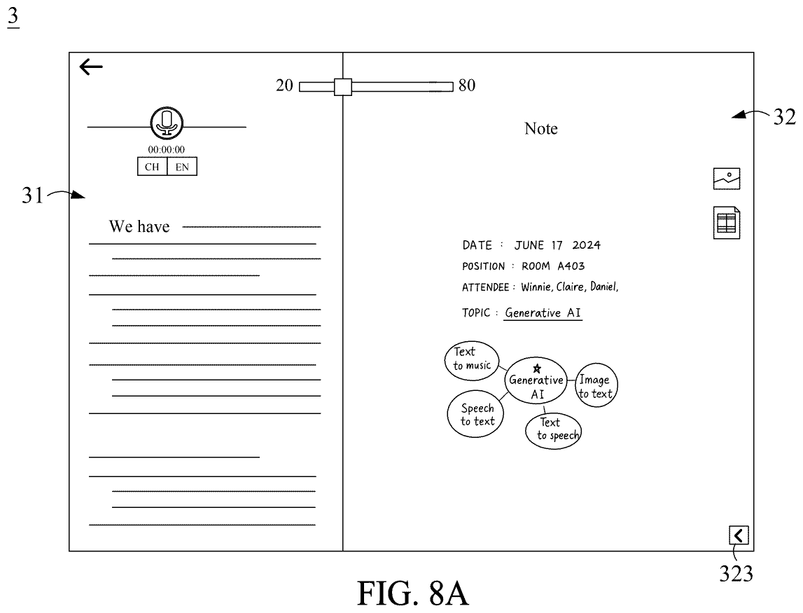

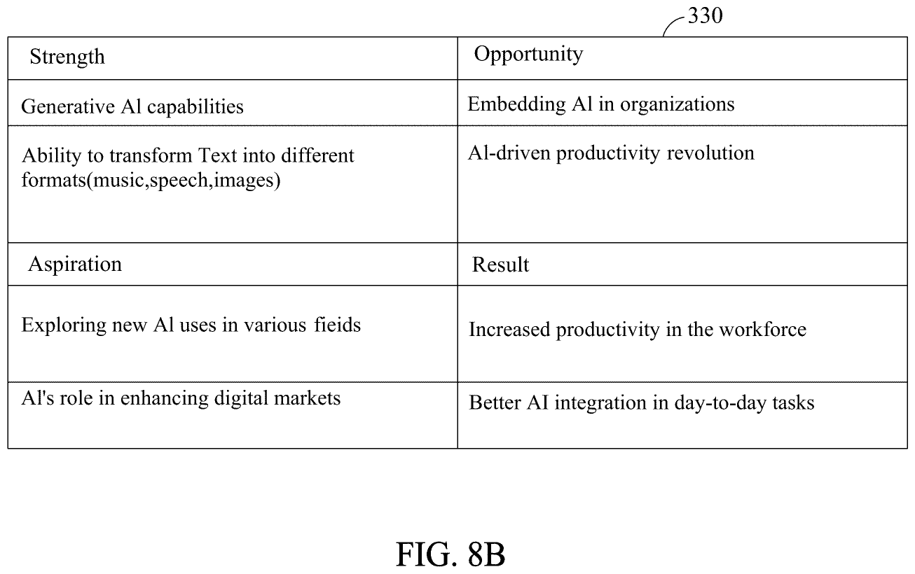

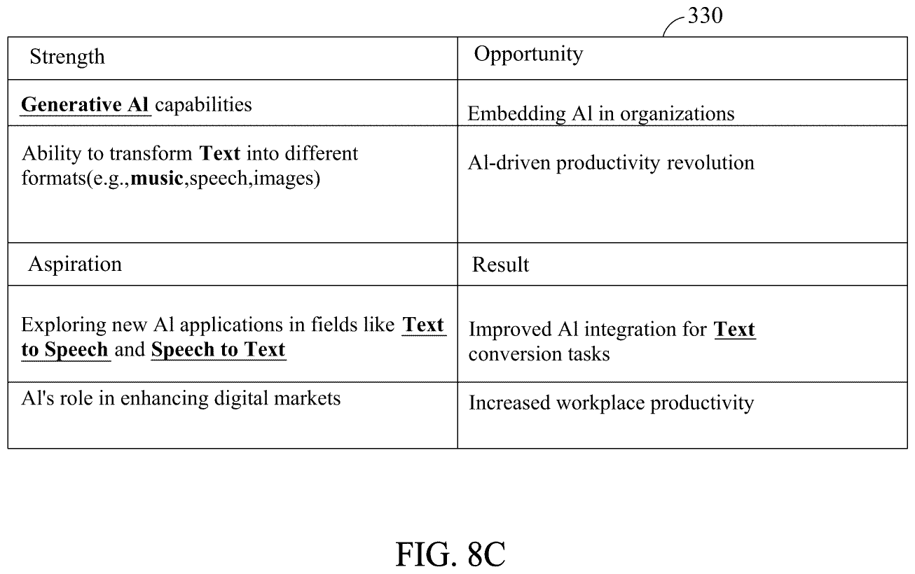

In some embodiments of the foregoing method, further referring to FIG. 8A, FIG. 8B, and FIG. 8C, the following step (not shown in the figure) is further included between step 52 and step 55. After step 52, the intelligent processing unit 4 first determines whether the word information or the handwriting recognition information has a specific marker (such as asterisking, circled word, or marked with fluorescent light, a triangle, or an asterisk symbol). When the word information or the handwriting recognition information has the specific marker (as shown in FIG. 8A, the specific marker of the handwriting recognition information is an asterisk and the word is circled/underlined), the intelligent processing unit 4 generates key handwriting information based on the word corresponding to the specific marker, and then performs step 53. When the word information or the handwriting recognition information is determined to have no specific marker, the intelligent processing unit directly performs step 53, which is not limited thereto. For example, the foregoing operation of determining whether the specific marker exists and whether the key handwriting information is generated may be performed after step 53 ends and before step 54 is performed, or after step 54 ends and before step 55 is performed. When the word information or the handwriting recognition information is determined to have the specific marker, in step 55, the intelligent processing unit 4 uses the generative AI to generate the AI-generated content based on the word information, the handwriting recognition information, the weight adjustment ratio information, the AI data processing mode, and the key handwriting information. The word related to the key handwriting information in the AI-generated content is presented in a different display manner (for example, the related word is underlined correspondingly, a font becomes bold, or a font size is changed), and a proportion of the content corresponding to the specific marker displayed in the AI-generated content is increased. For example, when the word information or the handwriting recognition information is determined to have no specific marker (as shown in FIG. 7A), the AI-generated content generated by the intelligent processing unit 4 is shown in the display area 330 of FIG. 8B. When the word information or the handwriting recognition information is determined to have the specific marker, FIG. 8A is used as an example, and the AI-generated content generated by the intelligent processing unit 4 is shown in the display area 330 of FIG. 8C. Compared with FIG. 8B, in FIG. 8C, the word related to the key handwriting information in the AI-generated content is underlined correspondingly and/or the font becomes bold, and the proportion of the content corresponding to the specific marker displayed in the AI-generated content is increased, which is not limited thereto.

In some embodiments of the foregoing method, the following step (not shown in the figure) is further included between step 52 and step 55. After step 52 ends, the intelligent processing unit 4 first determines whether a total number of words of the handwriting recognition information is less than a preset number of words. When the total number of words is less than the preset number of words, the intelligent processing unit 4 generates a warning window, and displays the warning window on the graphical user interface 3 (not shown in the figure), and then performs step 53 when the user adds words in the second display block 32 and the total number of words is not less than the preset number of words, which is not limited thereto. In another embodiment, when the total number of words is determined to be less than the preset number of words, the intelligent processing unit 4 directly ends the operation. On the contrary, after step 52 ends, when the intelligent processing unit 4 determines that the total number of words is not less than the preset number of words, the intelligent processing unit directly performs step 53, which is not limited thereto. For example, the foregoing operation of determining whether the total number of words is less than the preset number of words and whether the warning window is generated may be performed after step 53 ends and before step 54 is performed, or after step 54 ends and before step 55 is performed.

In some embodiments of the foregoing method, the following step (not shown in the figure) is further included between step 52 and step 54. After step 52 ends, the intelligent processing unit 4 splits the graphical user interface 3 into the first display block 31 and the second display block 32 (as shown in FIG. 2C) from up to down, or splits the graphical user interface 3 into the first display block 31 and the second display block 32 (as shown in FIG. 2A) from left to right based on the screen splitting selection operation performed by the user on the screen splitting element 312, and then performs step 53, which is not limited thereto. For example, the intelligent processing unit may also perform the foregoing screen splitting selection operation after step 53 ends and before step 54 is performed.

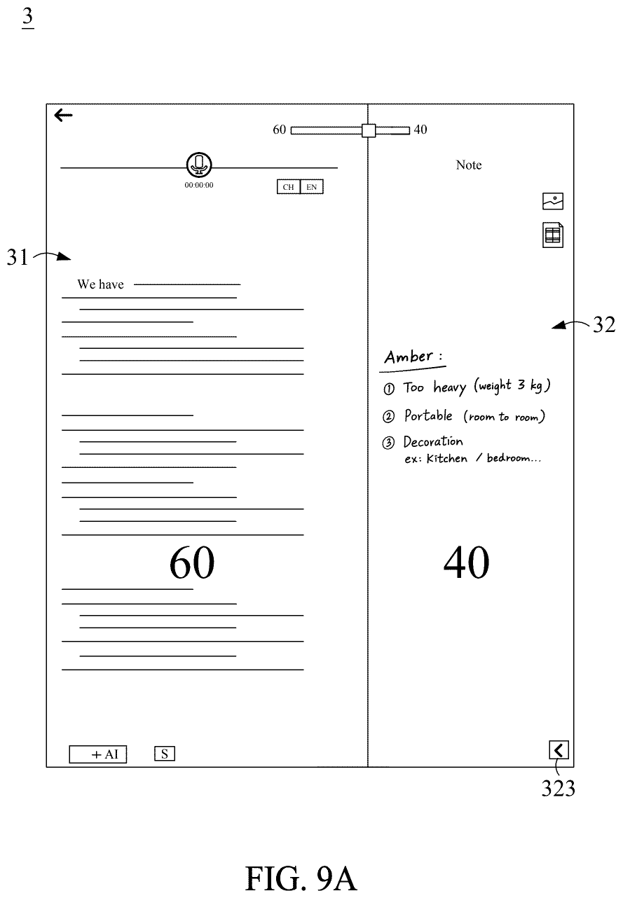

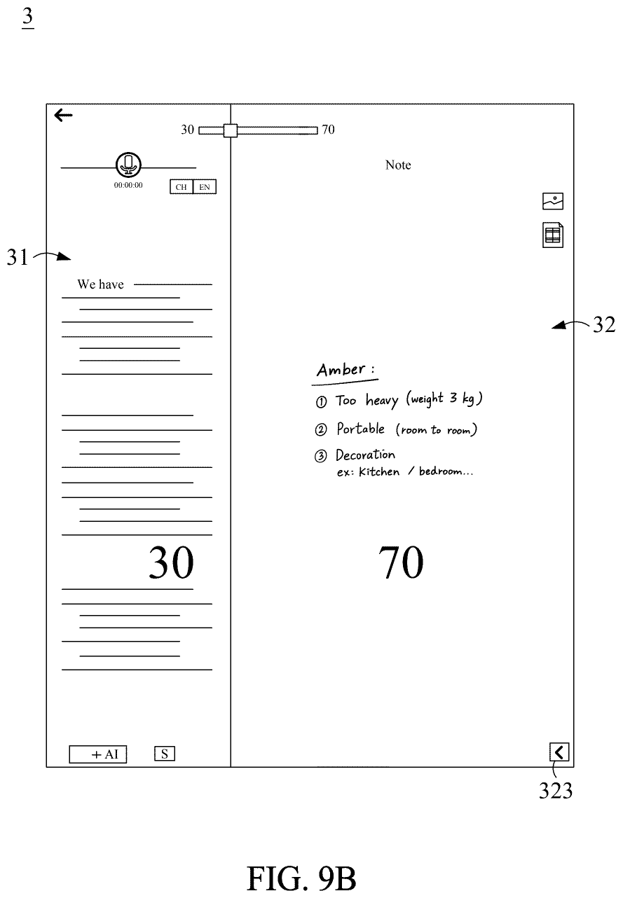

In some embodiments of the foregoing method, further referring to FIG. 9A and FIG. 9B, the following step (not shown in the figure) is further included after step 53. After step 53 ends, the intelligent processing unit 4 adjusts a display block size of each of the first display block 31 and the second display block 32 based on the weight adjustment ratio information (as shown in FIG. 9A and FIG. 9B), and then performs step 54, which is not limited thereto. For example, the foregoing operation of adjusting the display block size may also be performed after step 54 ends and before step 55 is performed. In another embodiment, the weight control bar 34 is, for example, a screen division line (not shown in the figure) of the graphical user interface 3. When the graphical user interface 3 is split from up to down, the user may adjust the weight adjustment ratio information by directly moving the screen division line, so as to correspondingly adjust respective generated weights of the content of the first display block 31 and the second display block 32, and/or adjust respective display block sizes of the first display block 31 and the second display block 32.

The present disclosure further provides a non-transitory computer-readable storage medium, storing the foregoing program instructions. The program instructions, after being read by the electronic device 1, is able to perform the method for processing data using generative AI in the present disclosure as shown in FIG. 4 based on the foregoing embodiments.

Based on the above, in the present disclosure, the electronic device 1 reads the program instructions to perform the method for processing data using generative AI. The program instructions may be stored in the non-transitory computer-readable storage medium. The method is performed and the screen of the graphical user interface 3 is split. In this way, the electronic device 1 is not required to open the plurality of application programs, so that more than two operation behaviors (for example, watch a verbatim copy of the meeting minutes, and simultaneously input an image or key minutes by hand) may be simultaneously performed on a single device through functional connection of a single application program, and the content (namely, the AI-generated content) of the processed read data may be displayed correspondingly, which is more convenient for the user to use. Moreover, the weight ratio of the content of the meeting minutes or the handwritten notes of the user is increased through the specific marker, so that the AI-generated content is more in line with preference of the user. In addition, while reading the first display block 31, the user can display the information of the advanced data search, the AI summary, or the article translation in the third display block 33 through splitting the screen. In addition, the user may freely adjust the weight adjustment ratio information through the weight control bar 34, and then freely adjust the weight of AI-generated content. In this way, the AI-generated content is more in line with the preference of the user and can enhance a personalized experience. In addition, the user participates in the generation process of the AI-generated content by adjusting the weight control bar 34, so as to improve user experience instead of passively accepting a generated result, which can enhance interactivity and heighten a human-machine interaction effect. In addition, because the weight control bar 34 may be dynamically controlled/flexibly applied, the user is allowed to adjust the AI-generated content in different application scenarios in real time, and may switch generation strategies flexibly without redesigning a generation model.

However, the above are only embodiments of the present disclosure and should not be used to limit the scope of implementation of the present disclosure. All simple equivalent changes and modifications made based on the scope of the patent application of the present disclosure and the content of the patent specification still fall within the scope of the patent of the present disclosure.

What is claimed is:

1. A method for processing data using generative artificial intelligence (AI), executed by an electronic device running a plurality of program instructions, and comprising the following steps:
(A) obtaining and displaying corresponding word information based on a startup input operation performed by a user;
(B) obtaining and displaying corresponding handwriting recognition information based on a handwriting input operation performed by the user;
(C) generating weight adjustment ratio information based on a generated content weight adjustment operation performed by the user;
(D) generating an AI data processing mode based on a generated content selection input operation performed by the user;
(E) generating an AI-generated content by using generative AI based on the word information, the handwriting recognition information, the weight adjustment ratio information, and the AI data processing mode; and
(F) displaying the AI-generated content.

2. The method according to claim 1, wherein between step (B) and step (E), the method further comprises the following steps:
(G) determining whether the word information or the handwriting recognition information has a specific marker; and
(H) generating key handwriting information based on a word corresponding to the specific marker when the word information or the handwriting recognition information has the specific marker, wherein
when the word information or the handwriting recognition information has the specific marker, in step (E), the AI-generated content is generated through the generative AI based on the word information, the handwriting recognition information, the weight adjustment ratio information, the AI data processing mode, and the key handwriting information.

3. The method according to claim 2, wherein words related to the key handwriting information in the AI-generated content are presented in different display manners.

4. The method according to claim 1, wherein between step (B) and step (E), the method further comprises the following steps:
(I) determining whether a total number of words in the handwriting recognition information is less than a preset number of words; and
(J) generating and displaying a warning window when the total number of words is less than the preset number of words.

5. The method according to claim 1, wherein the electronic device comprises a graphical user interface, the graphical user interface has a first display block and a second display block, the word information is displayed in the first display block, the handwriting recognition information is displayed in the second display block, and between step (B) and step (D), the method further comprises the following step:
(K) splitting, based on a screen splitting selection operation performed by the user, the graphical user interface into the first display block and the second display block from up to down, or splitting the graphical user interface into the first display block and the second display block from left to right.

6. The method according to claim 1, wherein the electronic device comprises a graphical user interface, the graphical user interface has a first display block and a second display block, the word information is displayed in the first display block, the handwriting recognition information is displayed in the second display block, and after step (C), the method further comprises the following step:
(L) adjusting a display block size of each of the first display block and the second display block based on the weight adjustment ratio information.

7. The method according to claim 1, wherein a graphical user interface of the electronic device has a weight control bar, the weight control bar has an adjustment element and two variable number elements, and the user performs the generated content weight adjustment operation by moving the adjustment element or adjusting numbers of the variable number elements.

8. The method according to claim 1, wherein when the word information is related to content of meeting minutes, the AI data processing mode is a general format processing mode, a risk assessment processing mode, a goal-oriented processing mode, or an advantage analysis processing mode.

9. The method according to claim 1, wherein when the word information is related to read content, the AI data processing mode is a summary processing mode, an advanced search processing mode, or a translation processing mode.

10. A non-transitory computer-readable storage medium, storing a plurality of program instructions, the program instructions, after being read by an electronic device, being able to perform the method according to claim 1.

11. An electronic device for processing data using generative AI, comprising:
a storage unit, storing a plurality of program instructions;
a graphical user interface, having a first display block, a second display block, a third display block, and a weight control bar; and
an intelligent processing unit, electrically connected to the storage unit to read and execute the program instructions, to perform a plurality of following operations:
(A) obtaining word information based on a startup input operation performed by a user on the graphical user interface, and displaying the word information on the first display block;
(B) obtaining handwriting recognition information based on a handwriting input operation performed by the user on the second display block, and displaying the handwriting recognition information on the second display block;
(C) obtaining weight adjustment ratio information based on a generated content weight adjustment operation performed by the user on the weight control bar;
(D) obtaining an AI data processing mode based on a generated content selection input operation performed by the user on the third display block;
(E) generating an AI-generated content by using generative AI based on the word information, the handwriting recognition information, the weight adjustment ratio information, and the AI data processing mode; and
(F) displaying the AI-generated content on the third display block.

12. The electronic device according to claim 11, wherein between operation (B) and operation (E), the operations further comprise the following operations:
(G) determining whether the word information or the handwriting recognition information has a specific marker; and
(H) generating key handwriting information based on a word corresponding to the specific marker when the word information or the handwriting recognition information has the specific marker, wherein
when the word information or the handwriting recognition information has the specific marker, in the operation (E), the AI-generated content is generated through the generative AI based on the word information, the handwriting recognition information, the weight adjustment ratio information, the AI data processing mode, and the key handwriting information.

13. The electronic device according to claim 12, wherein words related to the key handwriting information in the AI-generated content are presented in different display manners.

14. The electronic device according to claim 11, wherein between the operation (B) and the operation (E), the operations further comprise the following operations:
(I) determining whether a total number of words in the handwriting recognition information is less than a preset number of words; and
(J) generating a warning window when the total number of words is less than the preset number of words, and displaying the warning window on the graphical user interface.

15. The electronic device according to claim 11, wherein the first display block has a screen splitting element, and between operation (B) and operation (D), the operations further comprise the following operation:
(K) splitting, based on a screen splitting selection operation performed by the user on the screen splitting element, the graphical user interface into the first display block and the second display block from up to down, or splitting the graphical user interface into the first display block and the second display block from left to right.

16. The electronic device according to claim 11, wherein after operation (C), the operations further comprise the following operation:
(L) adjusting a display block size of each of the first display block and the second display block based on the weight adjustment ratio information.

17. The electronic device according to claim 11, wherein the weight control bar has an adjustment element and two variable number elements, and the user performs the generated content weight adjustment operation by moving the adjustment element or adjusting numbers of the variable number elements.

18. The electronic device according to claim 11, wherein when the word information is related to content of meeting minutes, the third display block has a general format processing element, a risk assessment processing element, a goal-oriented processing element, and an advantage analysis processing element, and the user presses the general format processing element, the risk assessment processing element, the goal-oriented processing element, or the advantage analysis processing element in the third display block to perform the generated content selection input operation, so that the AI data processing mode is a general format processing mode, a risk assessment processing mode, a goal-oriented processing mode, or an advantage analysis processing mode.

19. The electronic device according to claim 11, wherein when the word information is related to read content, the third display block has a summary element, an advanced search element, and a translation element, and the user presses the summary element, the advanced search element, or the translation element in the third display block to perform the generated content selection input operation, so that the AI data processing mode is a summary processing mode, an advanced search processing mode, or a translation processing mode.

20. The electronic device according to claim 11, wherein when the word information is related to read content, the third display block has a user input interface, and the user selects the user input interface in the third display block to perform the generated content selection input operation, to generate the AI data processing mode.
